(19) United States
(12) Patent Application Publication
(10) Pub. No.: US 2021/0073458 A1
(43) Pub. Date: Mar. 11, 2021

(54) COMIC DATA DISPLAY SYSTEM, METHOD, AND PROGRAM

(71) Applicant: OPTIM CORPORATION, Saga (JP)

(72) Inventor: Shunji SUGAYA, Tokyo (JP)

(21) Appl. No.: 16/958,814

(22) PCT Filed: Dec. 27, 2017
(86) PCT No.: PCT/JP2017/047007

§ 371 Date: Jun. 29, 2020

(51) Int. Cl. G06F 40/106; G06F 3/0485; G06T 11/60; G06F 3/16; G06F 16/28; G06F 16/61; G06N 20/00

(52) U.S. Cl. CPC G06F 40/106; G06F 3/0485; G06T 11/60; G06N 20/00; G06F 16/285; G06F 16/61; G06F 3/16

(57) ABSTRACT

Provided is a system for displaying bins of an arbitrarily comic in sequence on a terminal in a manner of scrollable display. In a comic data display system (1), a control unit (10) executes a comic data acquisition module (11) to acquire comic capture data. The control unit (10) executes a bin display module (12), and arranges and displays the bins included in the acquired comic capture data in sequence according to a bin order database (31) which stores a learning result related to a conversion of bins of the comic data.

### TECHNICAL FIELD

The present disclosure relates to a comic data display system and method, and a program.

### BACKGROUND

Comics are entertainments that are popular with many users around the world.

In the past, a mainstream way to enjoy comics was to read contents printed on paper such as offprints and magazines. However, with the development of electronic devices such as mobile phone terminals, smart phones, and tablet terminals which can clearly display digital contents and have a communication function, using these electronic devices to read comics has gradually become the mainstream (Patent Document 1)

Document in the existing art
Patent document

Patent Document 1: Japanese Laid Open Patent Application No. 2016-134179.

### SUMMARY

### Problem to be Solved in the Invention

When comic data is displayed on a smart phone or a tablet terminal, the screen is scrolled vertically or horizontally to display the contents in sequence. In particular, when comic data is displayed in a small electronic device with a display screen of a size of about 4 inches to 6 inches, such as a smart phone, to improve the visibility of bins, it is preferable to display one bin on the display screen, and display one bin on the display screen each time the bins are converted. In this case, it is preferable to enlarge the size of the bin according to the size of the display screen and display the bin.

Furthermore, in comics, multiple bins are generally depicted on one page, and the size and arrangement of each bin are not fixed. In a case of enlarging the bins and displaying them on the screen one after another, the order in which the bins are displayed on the screen becomes a problem.

In view of such requirement, the present disclosure has been made to provide a system for displaying bins of an arbitrarily comic in sequence on a terminal in a manner of scrollable display.

### Solution to the Problem

The present disclosure provides the following solutions.

An invention according to a first feature provides a comic data display system for displaying comic data in a terminal. The comic data display system includes a bin order database, a comic data acquisition unit and a bin display unit. The bin order database is configured to store a learning result related to a conversion of bins of the comic data. The comic data acquisition unit is configured to acquire comic capture data capturing a comic. The bin display unit is configured to arrange and display bins included in the acquired comic capture data in sequence based on the bin order database.

According to the invention of the first feature, the bins extracted from the comic are arranged in sequence by using the bin order database storing the learned conversion of bins. Therefore, it is possible to provide a system capable of displaying the bins on the terminal in sequence in a scrollable manner, regardless of the size of the screen.

An invention according to a second feature provides a comic data display system according to the invention of the first feature, where the bin display unit arranges extracted bins in a vertical direction and displays the extracted bins in sequence through up and down sliding with respect to the terminal.

According to the invention of the second feature, the extracted bins are arranged in the vertical direction and displayed in sequence through up and down sliding with respect to the terminal. Therefore, it is possible to provide a system with rich user interfaces for displaying the bins by an operation of browsing the website with a browser.

An invention according to a third feature provides a comic data display system according to the invention of the first or second feature, where the bin display unit learns and stores the conversion of bins of the comic data for each user.

According to the invention of the third feature, the bins is displayed by using the database for learning and storing the conversion of bins for each user. Therefore, it is possible to provide a highly accurate system that can reflect habits and preferences of each user at the time of reading.

An invention according to a fourth feature provides a comic data display system according to the invention of the first feature, the bin display unit arranges the extracted bins in a horizontal direction and displays the extracted bins in sequence through left and right sliding with respect to the terminal.

According to the invention of the fourth feature, the bins are arranged and displayed in a direction of usually reading comics. Therefore, it is possible to provide a system capable of reading with a feeling like turning pages.

An invention according to a fifth feature provides a comic data display system according to the invention of the first feature. The comic data display system further includes: an effect sound database, configured to store a relationship between a content comprised in the comic data and an effect sound corresponding to the content, where the bin display unit is configured to, when displaying the bins, output sounds corresponding to the displayed bins based on the effect sound database.

According to the invention of the fifth feature, not only illustrations drawn in the comics are used, but also sounds are used. Therefore, it is possible to provide a system that allows a more lyrical and realistic feeling.

### Effect of the Invention

According to the present disclosure, it is possible to provide a system for any comic arranging and displaying the bins in sequence.

### BRIEF DESCRIPTION OF THE DRAWINGS

FIG. 1 is a block diagram illustrating hardware composition and software functions of a comic data display system 1 according to the present embodiment.

FIG. 2 is a diagram showing an example of a bin order database 34 according to the present embodiment.

FIG. 3 is a diagram showing an example of an effect sound database 32 according to the present embodiment.

FIG. 4 is a flowchart of a comic data display method according to the present embodiment.

FIG. 5 is a diagram for illustrating an action of a control unit 10 when the comic data display method is implemented.

FIG. 6 is a diagram following FIG. 5.

FIG. 7 is a schematic diagram illustrating a case where small bins are enlarged and displayed according to the present embodiment.

FIG. 8 is a schematic diagram illustrating a display mode in a case where bins are arranged in a vertical direction.

### DETAILED DESCRIPTION

Embodiments for implementing the present disclosure will be described below with reference to the drawings. It is to be noted that the embodiments are merely examples and not intended to limit the scope of the present disclosure.

### Composition of Comic Data Display System 1

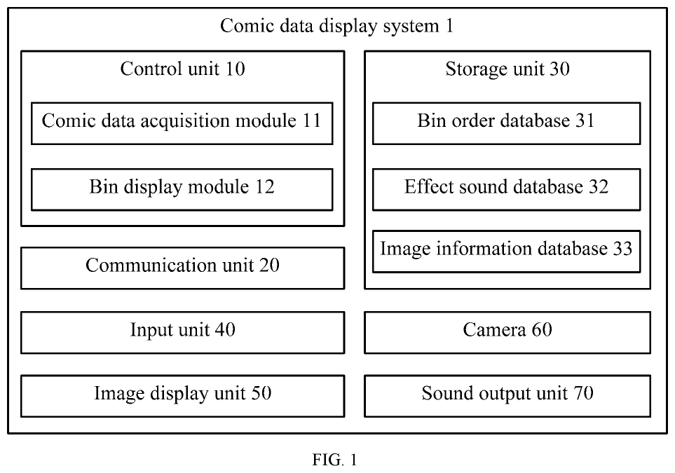

FIG. 1 is a block diagram illustrating hardware composition and software functions of a comic data display system 1 according to the present embodiment.

The comic data display system 1 includes: a control unit 10 which controls data; a communication unit 20 which communicates with other devices; a storage unit 30 which stores data; an input unit 40 which accepts user operations; an image display unit 50 which outputs and displays data and images controlled by the control unit 10; a camera 60 for acquiring the images; and a sound output unit 70 for outputting sounds.

The control unit 10 includes a central processing unit (CPU), a random access memory (RAM), a read only memory (ROM) and the like.

The communication unit 20 includes a device capable of communicating with other devices, such as a device compatible with wireless fidelity (Wi-Fi) compliant with IEEE802.11.

The control unit 10 reads a predetermined program and cooperates with the communication unit 20 as necessary, thereby implementing a comic data acquisition module 11 and a bin display module 12.

The storage unit 30 is a device for storing data and files and includes a data storage unit implemented by a hard disk, a semiconductor memory, a recording medium, a memory card or the like. The storage unit 30 stores a bin order database 31, an effect sound database 32, and an image information database 33. In addition, the storage unit 30 is capable of storing captured image data captured by the camera 60 described below.

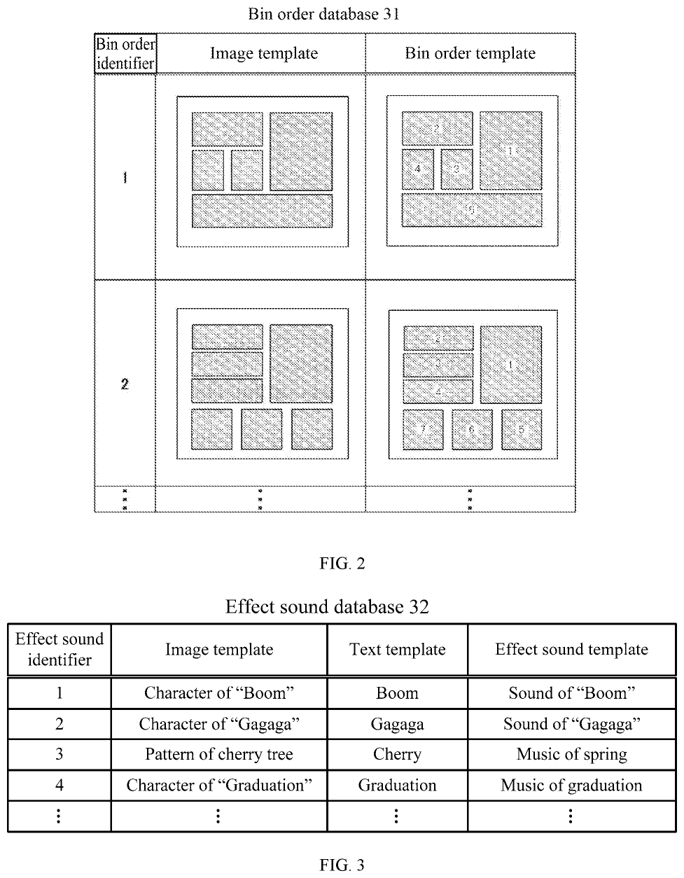

FIG. 2 is a diagram showing an example of the bin order database 31. An image template representing images of a comic allocated by bins and a bin order template representing a conversion order of the bins in the image template are correspondingly stored in the bin order database 31.

As an initial setting, on a provider side of the comic data display system 1, a correct conversion order of bins is stored as a bin order template for each of a large number of image templates. Furthermore, a provider of the comic data display system 1 causes the control unit 10 to perform a so-called artificial intelligence (AI) function and learn the correct conversion order of the bins.

For example, for a bin order identifier “1”, image templates representing images of bins allocation of a comic are stored in the bin order database 31. A file format of the image template is, but not particularly limited to, a form of image file. For example, it may be joint photographic experts group (JPEG) data, bitmap (BMP) data, or other file formats.

Moreover, the correct conversion order of the bins is stored in a storage area where the bin order template is stored. In this case, the conversion of the bins is shown in an order of “1”, “2”, “3” “4” and “5”.

FIG. 3 is a diagram showing an example of the effect sound database 32. An image template representing an image of characters or patterns included in a captured image of the comic, a text template corresponding to the image template, and an effect sound corresponding to the image template are stored correspondingly in the effect sound database 32.

As the initial setting, on the provider side of the comic data display system 1, text and an effect sound corresponding to the characters or patterns are respectively stored as the text template and the effect sound template for each of a large number of image templates. Furthermore, a provider of the comic data display system 1 causes the control unit 10 to perform the so-called artificial intelligence (AI) function and learn the correct effect sound.

For example, for the effect sound identifier “1”, the effect sound database 32 stores an image template representing an image of a character “Boom”. A file format of the image template is, but not particularly limited to, a form of image file. For example, it may be the JPEG data, the BMP data or other file formats.

Furthermore, in the storage area where the text template is stored, characters corresponding to a character image or a pattern image which is stored as the image template is stored as text data. For example, if the image data of the character “Boom” is stored as the image template, the text data of “Boom” is stored as the text template.

Furthermore, in the storage area where the effect sound template is stored, an effect sound corresponding to the character image or the pattern image which is stored as the image template is stored as sound data. A file format of an effect sound template is, but not particularly limited to, a form of image file. For example, it may be any one of: a waveform audio (WAVE) format, an audio interchange file format (AIFF) format, a moving picture experts group audio layer III (MP3) format, an advanced audio coding (AAC) format and a free lossless audio codec (FLAC) format, and may also be other file formats.

If the effect sound identifier is “1”, a sound file of the explosion sound “Boom” is stored as the effect sound template.

The image information database 33 stores information related to a size of the image display unit 60 described below. For example, information that the image display unit 60 has a size of 4 inches, a vertical pixel number of 1136 pixels and a horizontal pixel number of 640 pixels in a certain model is stored.

For example, information that the image display unit 60 has a size of 5.5 inches, a vertical pixel number of 1920 pixels and a horizontal pixel number of 1080 pixels in another model is stored.

Referring to FIG. 1 again, a type of the input unit 40 is not particularly limited. The input unit 40 may include, for example, a keyboard, a mouse, a touch panel and the like.

A type of the image display unit 50 is not particularly limited. The image display unit 50 may include, for example, a displayer, the touch panel and the like.

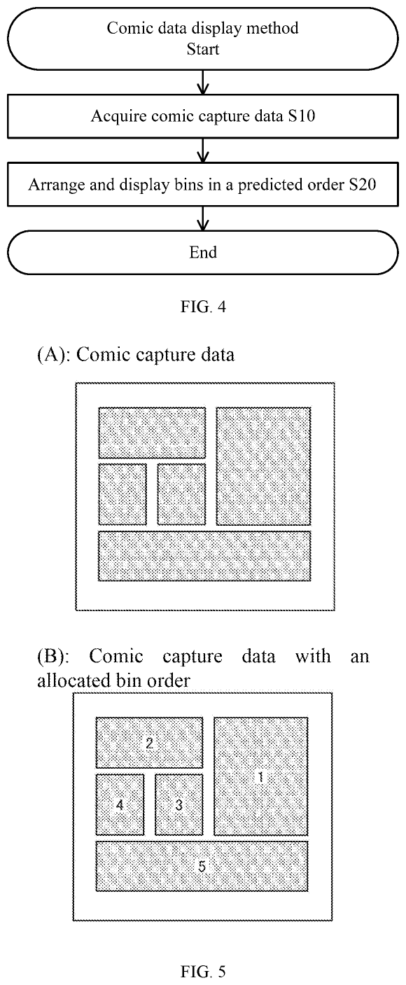

### Flowchart Illustrating a Comic Data Display Method of the Comic Data Display System 1 FIG. 4 is a flowchart illustrating a comic data display method of the comic data display system 1.

### Step S10: Image Acquisition

First, the control unit 10 of the comic data display system 1 executes the comic data acquisition module 11 to acquire comic capture data captured by the camera 60 (step S10).

FIG. 5(A) shows an example of the comic capture data captured by the camera 60. In the captured comic, multiple bins are depicted on a page, and the size and arrangement of each bin are not fixed.

### Step S20: Bin Display

Next, the control unit 10 executes the bin display module 12. In this case, the control unit 10 reads the bin order database 31 stored in the storage unit 30, predicts the correct order of multiple bins included in the comic capture data based on a bin order learned in the past, and cause the screen display unit 50 to display the multiple bins in sequence according to the predicted order (step S30).

In this process, the control unit 10 reads the bin order database 31 stored in the storage unit 30, performs image recognition on the comic capture data acquired in step S10, and searches the closest image template from the image templates stored in the bin order database 31. The method of image recognition is not particularly limited, and may be a method known hitherto.

For example, in a case where the comic capture data acquired in step S10 is data shown in FIG. 5 (A), the control unit 10 determines that the image template corresponding to the bin order identifier “1” is the closest image template.

Next, the control unit 10 reads a bin order template corresponding to the determined closest image template, and allocates a bin order corresponding to the read bin order template to the comic capture data acquired in step S10. FIG. 5 (B) shows an example of the comic capture data after the bin order is allocated.

Next, the control unit 10 extracts the bins one by one from the comic capture data in the allocated bin order, and displays them in the image display unit 50.

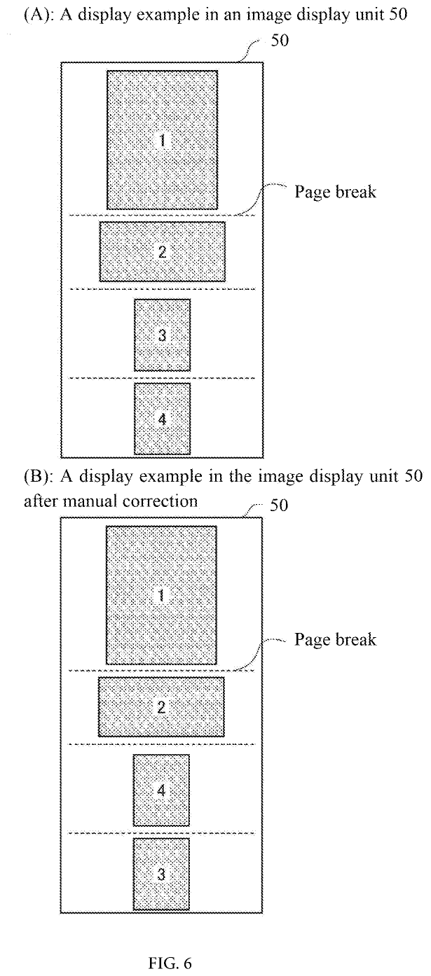

FIG. 6(A) shows a display example in the image display unit 50 at this time. Comics are displayed in the image display unit 50 in an order corresponding to the bin order template. In FIG. 6 (A), a line inserted between bins represents a page break.

In addition, the order of bins displayed by the image display unit 50 may be incorrect. Therefore, the user may confirm the order of the bins displayed on the screen display unit 50, and corrects the order by manual replacement if necessary. The control unit 10 may perform replacement of the bin order according to the correction instruction operation. If the order is corrected, the corrected order is determined as the order of bins, if the order is not corrected, the original order is determined as the order of bins.

FIG. 6(B) shows a display example in the image display unit 50 when the correction is performed. As compared with FIG. 6 (A), the order of a bin set to a third bin and a bin set to a fourth grid is replaced.

The control unit 10 causes the bin order database 31 of the storage unit 30 to store the bin order determined in this way, so that the control unit 10 may learn it as new data for future prediction. In addition, learning content data may be transmitted to a server (not shown) managed by the provider of the comic data display system 1. The server receives information of multiple users, and transmits the received information to the user's terminal (the comic data display system 1) at a predetermined timing, thereby improving performance of AI function of the control unit 10 of the comic data display system 1.

In addition, magnification may be changed according to the size of the screen to display the size of the bin. For example, the control unit 10 calculates a size of each bin included in the comic capture data, and disposes the each bin in a predetermined area of the storage unit 30. Moreover, the control unit 10 reads the image information database 33, and calculates, for each bin, the magnification that may be displayed by the image display unit 50 and may be displayed as large as possible. Furthermore, the control unit 10 enlarges and displays the each bin included in the comic capture data at the calculated magnification.

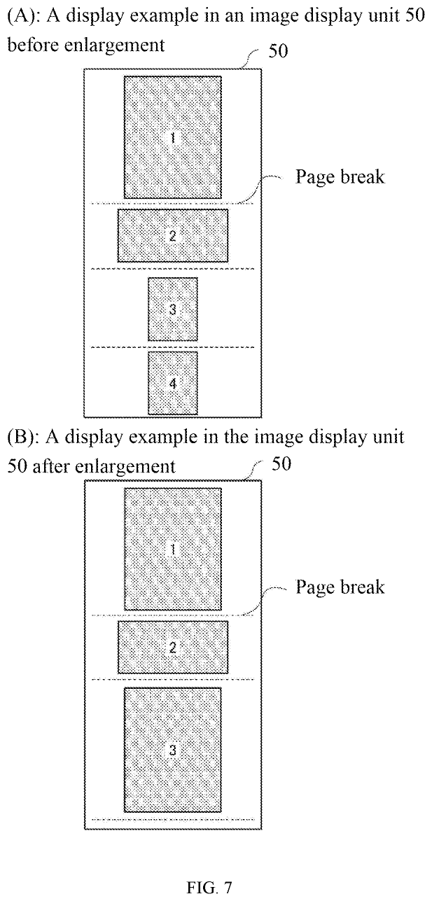

For example, as shown in FIG. 7 (A), in a case where the bin is small and difficult to see, the size of the bin may be changed such that the bin fits on the screen, as shown in FIG. 7 (B). With such configuration, it is possible to construct a comic data display system 1 in which a user is able to easily and visually recognize the contents even in a terminal with a small screen such as a smart phone.

In this embodiment, the bins are displayed in one column on each screen, but the bins may also be configured to be displayed in two or more columns according to the size of the terminal screen. For example, a smartphone may be set to display the bins in one column, and a tablet terminal having a screen of 10 inches or more may be set to display the bins in two columns. With such configuration, it is possible to achieve an excellent comic data display system that is easy to use while fully exerting the terminal's screen display performance.

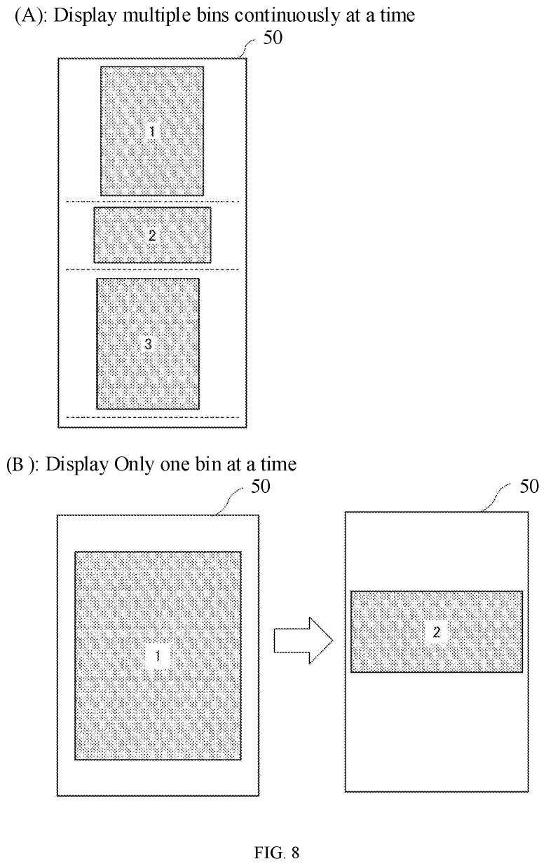

FIG. 8 is a schematic diagram illustrating a display mode in a case where bins are arranged in a vertical direction. As a method of displaying bins on the screen, there are a method of scrolling and displaying multiple continuously-displayed bins as shown in FIG. 8 (A), and a method of displaying only one bin at a time and displaying the next bin by clicking or touching the screen as shown in FIG. 8 (B). In a case of a method in which multiple bins are continuously displayed as shown in FIG. 8 (A), scrolling may be performed at a user's favorite speed so that reading may be advanced at a speed matching the user's preference. On the other hand, in a case of a method in which only one bin is displayed at a time as shown in FIG. 8 (B), contents of a subsequent bin is not known before the display so that a display system that allows a more immersive and realistic feeling can be constructed.

In addition, in the present embodiment, description has been made on the premise that the bins are arranged in the vertical direction, but the direction in which the bins are arranged may be vertical direction or the horizontal direction. In a case of arranging the bins in the vertical direction, neatly arranged bins are display by scrolling the screen up and down, but in a case of arranging the bins in the horizontal direction, the bins are display by scrolling the screen left and right.

Furthermore, in this embodiment, the learning method for bin allocation is configured such that a database is constructed for each user, and the conversion of bins is determined based on the database. With such system, a database that reflects the user's reading habits and preferences can be constructed. Therefore, a comic data display system, which has lower need for correction as more learning is performed and fits the user's preferences, can be achieved.

Alternatively, a database storing data for the bin allocation by various users may be used to replace a database for each user via the network. In this case, reading the database in step S20 is executed in cooperation with the communication unit 20. Like this, in a case of using a database that stores data based on many users, it is highly likely that bin order data for a comic which is the same as the comic to be analyzed exists, so that an excellent comic data display system, which can save analyzing and capturing time and is easy to use, can be achieved.

In addition, the comic data display system 1 may be configured to not only display the extracted comic capture data on the screen, but also output sounds at the same time. That is, according to the comic, effect sounds such as “Boom” and “Gagaga . . . ” may be recorded in the bins. In this case, the control unit 10 reads the effect sound database 32 to read the character string or specific pattern included in the comic capture data. The method for reading the character string may be a conventionally known character recognition method, which is not particularly limited. The method for reading the specific pattern may be a conventionally known image recognition method, which is not particularly limited.

Then the control unit 10 reads the effect sound corresponding to the recognized character column or pattern, and outputs the effect sound from a sound output unit 70 while the recognized character string or pattern is displayed on the image display unit 50. As a result, a comic data display system that allows a more realistic feeling can be constructed.

Alternatively, in addition to the effect sound actually recorded as a character, a sound other than the actual recorded onomatopoeias may be output. For example, when a bin with an illustration of a cherry tree is displayed, a music reminiscent of spring is output, or when a character of “graduation” is recognized, a music related to graduation is output. With such a system configuration, a comic data display system that allows a more lyrical and realistic feeling can be constructed.

The embodiment of the present disclosure has been described above, but the present disclosure is not limited to the above embodiment. In addition, effects described in the embodiment of the present disclosure are the best effects for the present disclosure.

### DESCRIPTION OF REFERENCE NUMERALS

1 comic data display system
10 control unit
11 comic data acquisition module
12 bin extraction module
20 communication unit
30 storage unit
31 bin order database
32 effect sound database
33 screen information database
40 input unit
50 image display unit
60 camera
70 sound output unit.

1-7. (canceled)

8. A comic data display system for displaying comic data on a terminal, comprising:
a bin order database, configured to store a learning result related to a conversion of bins of the comic data;
a comic data acquisition unit, configured to acquire comic capture data of a captured comic; and
a bin display unit, configured to arrange and display bins, which are comprised in the acquired comic capture data, in sequence based on the bin order database.

9. The comic data display system of claim 8, wherein the bin display unit is configured to arrange extracted bins in a vertical direction and display the extracted bins in sequence through up and down sliding with respect to the terminal.

10. The comic data display system of claim 8, wherein
the bin order database is a database obtained by learning a conversion of bins of the comic data for each user.

11. The comic data display system of claim 8, wherein the bin display unit is configured to arrange extracted bins in a horizontal direction and display the extracted bins in sequence through left and right sliding with respect to the terminal.

12. The comic data display system of claim 8, further comprising:
an effect sound database, configured to store a relationship between a content comprised in the comic data and an effect sound corresponding to the content,
wherein the bin display unit is configured to, when displaying the bins, output sounds corresponding to the displayed bins based on the effect sound database.

13. A comic data display method, executed by a comic data display system that displays comic data on a terminal, comprising:
acquiring comic capture data of a captured comic; and
arranging and displaying bins, which are comprised in the acquired comic capture data, in sequence according to a bin order database which stores a learning result related to a conversion of bins of the comic data.

14. A computer-readable program for causing a computer displaying comics on a terminal to execute:
acquiring comic capture data of a captured comic; and
arranging and displaying bins, which are comprised in the acquired comic capture data, in sequence according to a bin order database which stores a learning result related to a conversion of bins of the comic data.

15. The comic data display system of claim 9, wherein
the bin order database is a database obtained by learning a conversion of bins of the comic data for each user.

16. The comic data display system of claim 9, further comprising:
an effect sound database, configured to store a relationship between a content comprised in the comic data and an effect sound corresponding to the content,
wherein the bin display unit is configured to, when displaying the bins, output sounds corresponding to the displayed bins based on the effect sound database.

17. The comic data display system of claim 10, further comprising:
an effect sound database, configured to store a relationship between a content comprised in the comic data and an effect sound corresponding to the content,
wherein the bin display unit is configured to, when displaying the bins, output sounds corresponding to the displayed bins based on the effect sound database.

18. The comic data display system of claim 11, further comprising:
an effect sound database, configured to store a relationship between a content comprised in the comic data and an effect sound corresponding to the content,
wherein the bin display unit is configured to, when displaying the bins, output sounds corresponding to the displayed bins based on the effect sound database.

19. The comic data display system of claim 15, further comprising:
an effect sound database, configured to store a relationship between a content comprised in the comic data and an effect sound corresponding to the content,
wherein the bin display unit is configured to, when displaying the bins, output sounds corresponding to the displayed bins based on the effect sound database.
